(19) United States
(12) Patent Application Publication
(10) Pub. No.: US 2002/0091724 A1
(43) Pub. Date: Jul. 11, 2002

(54) Printing method and controller for granting permission to interrupt requests at multiple page intervals

(75) Inventor: Takeshi Yokoe, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/040,387

(22) Filed: Dec. 31, 2001

(30) Foreign Application Priority Data
Jan. 10, 2001 (JP) 2001-002269

(51) Int. Cl. G06F 15/00; G06F 17/00; G06F 17/21; G06F 17/24

(52) U.S. Cl. 707/500

(57) ABSTRACT

In a printer controller, first and second interfaces are respectively associated with first and second print data sources. Print data from each of the first and second print data sources is divided into data blocks each containing multiple pages. When the first interface is enabled, a data block of the first print data is printed, and the process continues on the next data block if no print request is received from the second print data source. If the second print data source is requesting a print interrupt, control is granted to the second interface when multiple pages of the first print data source have been printed.

### BACKGROUND OF THE INVENTION

1. Field of the Invention

The present invention relates to a method and printer controller for printing data by granting permission to a print request from a second data source by interrupting the printing process of a first data source.

2. Description of the Related Art

With the advances in computer's serial bus systems such as IEEE 1394 and USB (universal serial bus), there is a growing need to directly attach peripheral devices to a printer bypassing a host computer. Scanners and digital cameras are examples of such peripheral devices. In a computer system where a scanner is directly attached to a printer, the printer is connected to the host computer via a network interface such as a TCP/IP interface. In such systems, there are frequent instances that the printer receives print requests from the host computer and the scanner almost simultaneously. Control is usually granted to the data source that wins the race for competition. If the winner data source has a large amount of print data, the loser data source has to wait an extended period of time. In an office environment, in particular, if the scanner cannot interrupt the printing process of the host computer, the operator would be frustrated, standing in the neighborhood of the scanner waiting for the host computer to end its routine.

Japanese Patent Publication 3-262673 discloses a printer controller that operates on an interrupt request mode using a high capacity memory. When an interrupt request is generated during a printing process, the request is granted to interrupt the current process by saving printed and unprinted data in a stack area of the memory to maintain this memory status until the end of the interrupting process.

Japanese Patent Publication 6-103005 discloses a printer controller that allows a print request to interrupt at page intervals. However, interrupt can occur even if the current data can be processed in a short period of time. Additionally, since the print data are structured so that each page print data is independent from other page print data, there is no information that can be shared among different pages. As a result, the amount of data to be supplied from the host computer increases, requiring a CPU and a display processor of higher speed capability in comparison with a print mode in which page dependent description language is used.

### SUMMARY OF THE INVENTION

It is therefore an object of the present invention to provide a method and printer controller for interrupt mode printing without requiring high capacity memories.

According to one aspect of the present invention, there is provided a printing method comprising the steps of dividing print data of a first print data source into a plurality of data blocks each containing a plurality of pages, generating resource data from a data block of the first print data and converting the data block to display data using the resource data, printing the display data, and clearing the resource data and granting permission to a print request from a second print data source when the display data of the first data source has been printed.

According to a second aspect, the present invention provides a printing method for first and second print data sources which respectively produce first and second print data, each of the first and second print data containing a plurality of pages. The method comprises (a) printing a data block of the first print data when the first print data source is requesting a print of the first print data, (b) repeating step (a) if the second print data source is not requesting a print of the second print data, and (c) printing a data block of the second print data if the second print data source is requesting a print of the second print data.

According to a third aspect of the present invention, there is provided a printer controller comprising first and second interfaces respectively connected to first and second print data sources, the first and second print data sources respectively producing first and second print data, each of the print data comprising a plurality of data blocks each containing a plurality of pages. A control module is provided for receiving a data block of the first print data from the first interface if the first print data source is requesting a print of the first print data for printing on a printer, and receiving a data block of the second print data from the second interface for processing on the printer if the second print data source is requesting a print of the second print data when the data block of the first print data has been printed. In stead of the first print data.

### BRIEF DESCRIPTION OF THE DRAWINGS

The present invention will be described in detail further with reference to the following drawings, in which:

FIG. 1 is a block diagram of a printer controller of the present invention;

FIG. 2 is an illustration of a data format in which configuration data and print data are assembled by a print data source according to a first embodiment of the present invention;

FIG. 3 is a flowchart of the operation of a control module according to the first embodiment of the present invention;

FIG. 4 is an illustration of a data format in which configuration data and print data are assembled by a print data source according to a second embodiment of the present invention;

FIG. 5 is a flowchart of the operation of a control module according to the second embodiment of the present invention;

FIG. 6 is an illustration of a data format in which configuration data and print data are assembled by a print data source according to a third embodiment of the present invention; and

FIG. 7 is a flowchart of the operation of a control module according to the third embodiment of the present invention.

### DETAILED DESCRIPTION

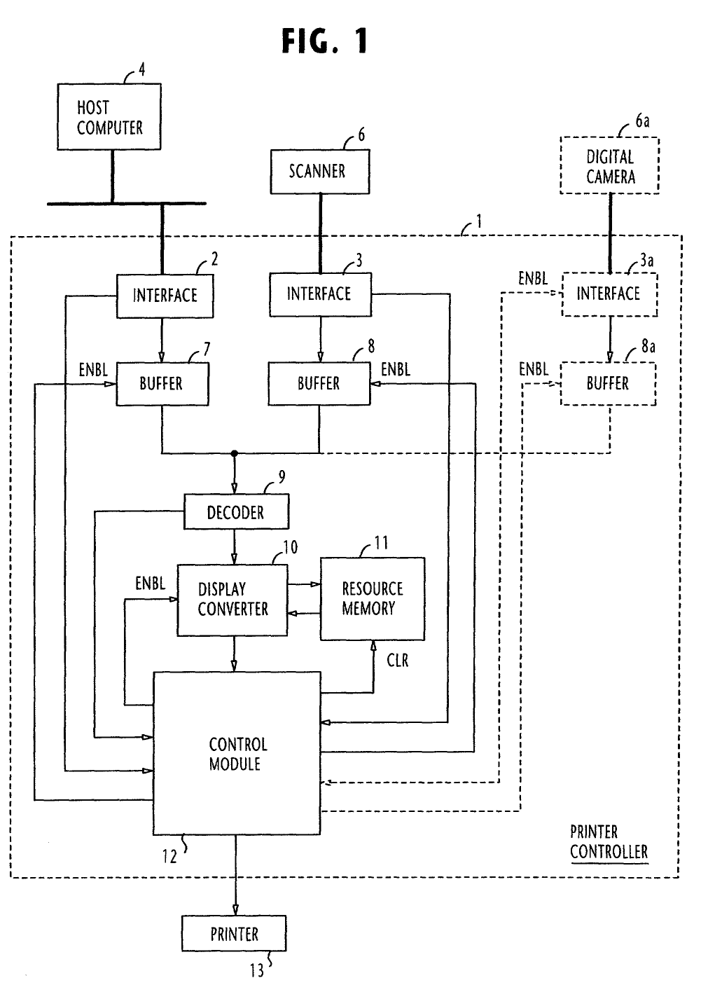

Referring to FIG. 1, there is shown a printer controller 1 according to the present invention. Printer controller 1 includes a plurality of interfaces 2 and 3 connected to a host computer 4 and a scanner 6, respectively. Buffers 7 and 8 are connected to the interfaces 2 and 3 to store print data on a per data block basis from the associated interfaces, as described later. A control module 12 monitors the interfaces 2 and 3 to enable one of the buffers according to an algorithm described in detail later if the control module 12 receives a print request signal simultaneously from the interfaces 2 and 3.

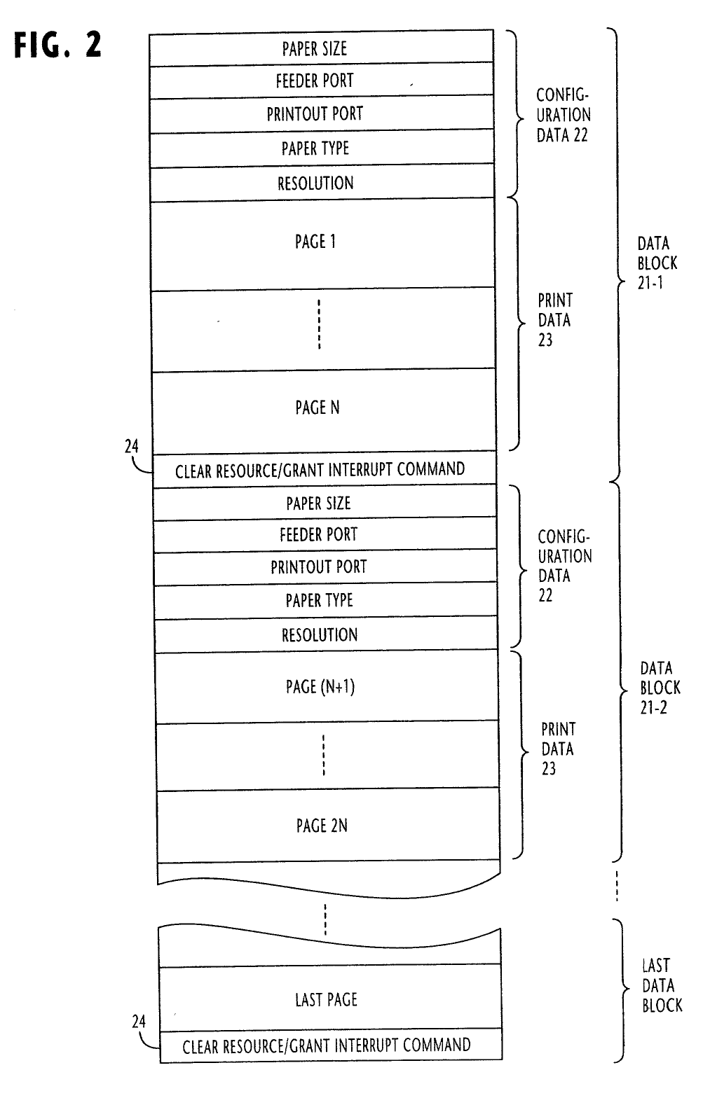

According to one embodiment of the present invention, each of the data sources 4 and 6 formulates print data according to predetermined form as shown in FIG. 2. As illustrated, the print data from the computer 4 and scanner 6 is composed of a plurality of data blocks 21, each comprising configuration data 22, multiple page print data 23 containing pages 1 to N, and a clear resource/grant interrupt command 24. The configuration data 22 contains information as to page size, paper feed port, printout port, paper type and image resolution.

Connected to the outputs of buffers 7 and 8 is a decoder 9 which examines the type of data supplied from the enabled buffer and supplies information to the control module 12 as to whether the data is configuration data, page print data or a command signal. If the configuration data is detected by the decoder, the control module 12 sets the printer 13 according to the configuration data. If print data is detected by the decoder 9 and the detected print data needs conversion to bit map data, the control module 12 instructs the display converter 10 to convert the print data to bit map data by using resource data which is generated and stored in a resource memory 11. The resource data is of the type of information that can be repeatedly used for the data conversion so that it can reduce the amount of memory required and increase the processing speed. Alphanumeric fonts and repeated patterns are examples of such resource data. The bit map data is supplied from the printer controller 1 to the printer 13 and printed.

The printing process on a given data block continues without interruption until N pages are printed. When this occurs, the control module 12 receives a command signal 24 from the decoder 9 and clears the resource data in memory 11 and interrupts the current printing process if a print request is received from the other interface.

Print data from each interface is stored into the associated buffer on a per data block basis. Alternatively, an integral multiple of data blocks is stored so that no data blocks are split and stored in the buffer.

While two buffers are illustrated, it may be sufficient to provide only one buffer as a common memory for the interfaces 2 and 3 if the sole buffer is enabled to accept only one full data block at a time. An additional peripheral device 6a such as a digital camera, an interface 3a and a buffer 8a may be further provided as required.

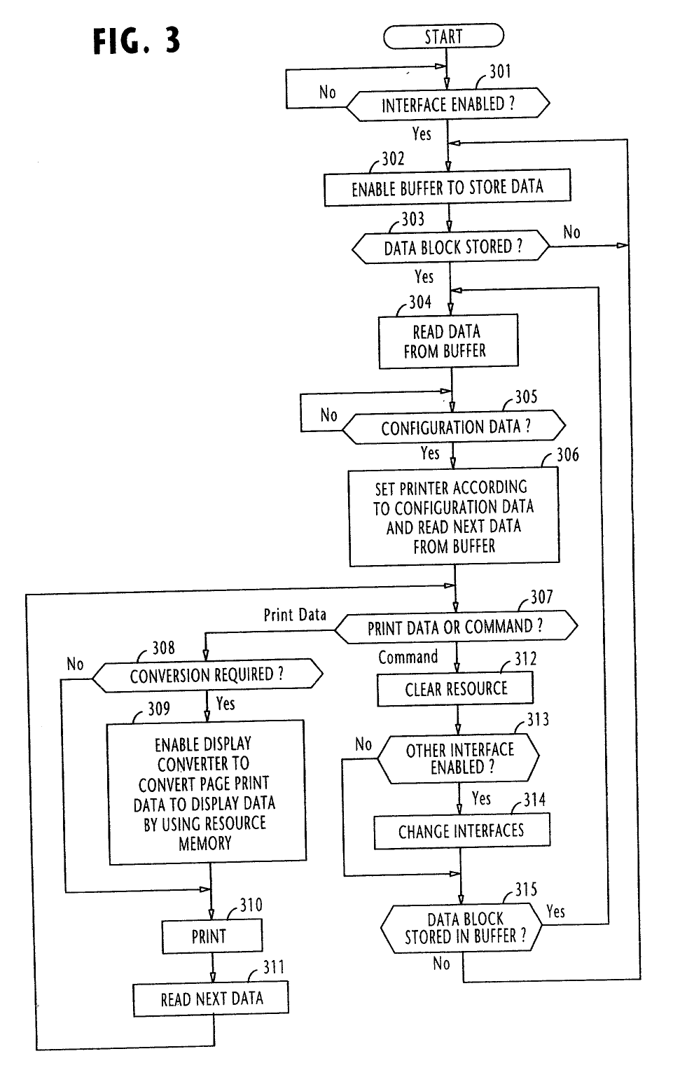

The following is a description of the operation of control module 12 when processing the data format of FIG. 2 with reference to FIG. 3.

Control module 12 starts the routine at step 301 by checking to see if one of the interfaces is enabled by the associated print source. If one of the interfaces 2 and 3 is enabled, the control module 12 proceeds to step 302 to enable the associated buffer to store print data and monitors the buffer at step 303 and repeats steps 302 and 303 until at least one data block is stored in the buffer. If the decision is affirmative at step 303, flow proceeds to step 304 to enable the buffer associated with the enabled interface to read the stored data out of the buffer into the decoder 9. Thus, the configuration data is detected at step 305 and the control module 12 sets the printer 13 according to the configuration data supplied from the decoder 9, and enables the buffer to read the next data (step 306).

Flow proceeds to decision step 307 to determine whether the data read out of the enabled buffer is page print data 23 or a command signal 24.

If the data read out of the buffer is page print data, the control module 12 proceeds from step 307 to step 308 to determine whether the print data needs to be converted to bit map data. If the print data is bit map data, no data conversion is required and flow proceeds from step 308 to step 310 to supply the bit map data to the printer 13. Control module 12 reads the next data (step 311) and returns to decision step 307.

If the control module has determined that print data needs data conversion, the decision at step 308 is affirmative and flow proceeds to step 309 to enable the display converter 10 to convert the print data to bit map data using resource data, which is generated from page print data and stored in the resource memory 11. The resource data is thus generated from N-page print data and made available as a common reusable resource for N pages of the same data block. At step 310, the control module 12 supplies the converted display data to the printer and read the next data (step 311) and returns to step 307 to determine the type of data. In this way, steps 307 to 311 are repeatedly executed and pages 1 to N of a data block are printed without interruption.

When page N has been printed, the decision at step 307 will indicate that a clear resource/grant interrupt command is produced by the decoder 9. Flow proceeds from step 307 to step 312 to clear the resource data of a data block from the resource memory 11. Therefore, reference to resource data is performed among the page print data of the same data block. No reference is made between different data blocks for converting print data to display data.

At decision step 313, the control module 12 determines whether the other interface has been enabled. If so, flow proceeds to step 314 to grant permission to print by interrupting the current printing and change interfaces. At step 315, the control module checks the buffer associated with the newly granted interface to see if it stores data. If no data block is stored in this buffer, flow returns to step 302 to enable it to store data from the associated interface until at least one data block is stored (step 303). If a data block is stored in the new buffer, flow proceeds to step 304. Thus, a printing process is performed on data supplied from the buffer of the newly enabled interface. If the decision at step 313 is negative, the control module 12 continues printing on the print data of the current interface by returning to step 302 or 304 depending on whether or not the next data block is stored in the current buffer (step 315).

Note that if only one buffer is provided and the control module 12 directs it to store a data block at a time, there is no remaining data in the buffer. In that instance, decision step 315 can be dispensed with.

As a result, the print process of a given interface is interrupted for another interface only when multiple page data of the given interface have been printed.

It will be seen that, when a clear resource/grant interrupt command is detected during the process of the new interface, this process is interrupted and the previously interrupted printing will be resumed.

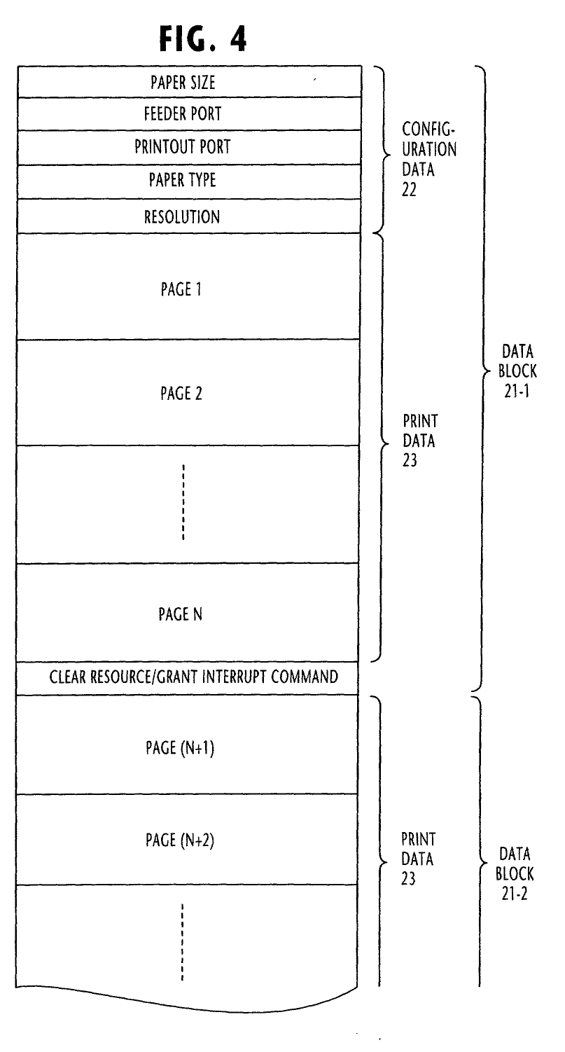

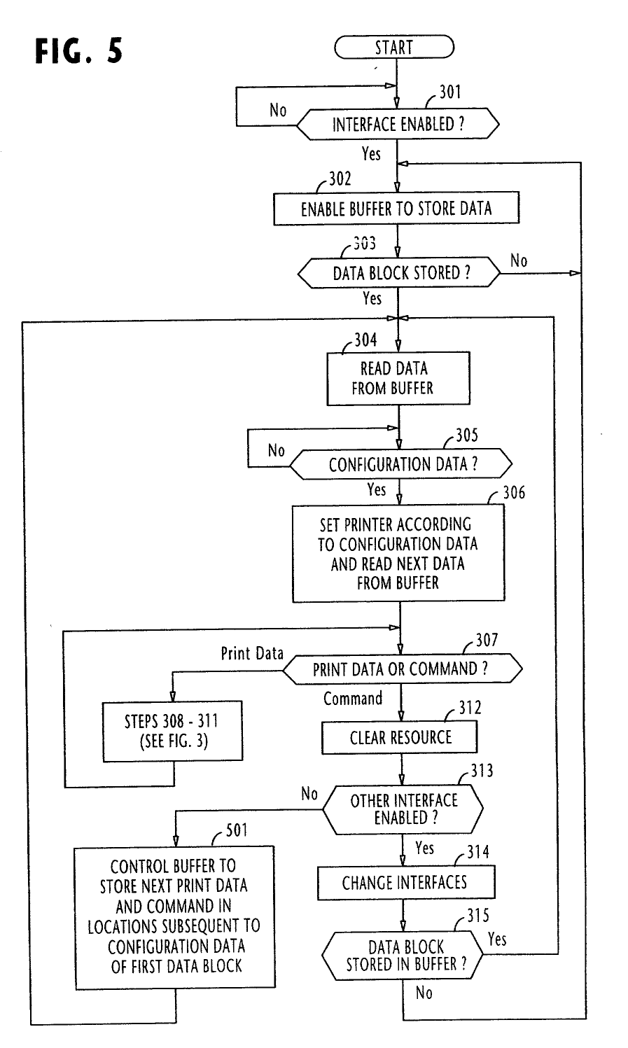

A modified print data format is shown in FIG. 4. In this modification, the configuration data is only contained in the first data block 21-1. Corresponding to this modification, the flowchart of FIG. 3 is modified by the inclusion of step 501, as shown in FIG. 5. Control module 12 proceeds from decision step 313 when there is no enabled interface other than the current interface. At step 501, the control module enables the current buffer to store the print data and the associated clear resource/grant interrupt command of the next data block 21-2 in buffer locations where the previous print data and command have been stored, leaving the configuration data of data block 21-1 in the buffer. Following the execution of step 501, the control module 109 returns to decision step 303 to check to see if the next full data block is stored in the buffer. If so, the control module proceeds to step 304 to start reading data from the next data block. Thus, the previously stored configuration data is detected at step 305 and the printer 13 is set according to this configuration data.

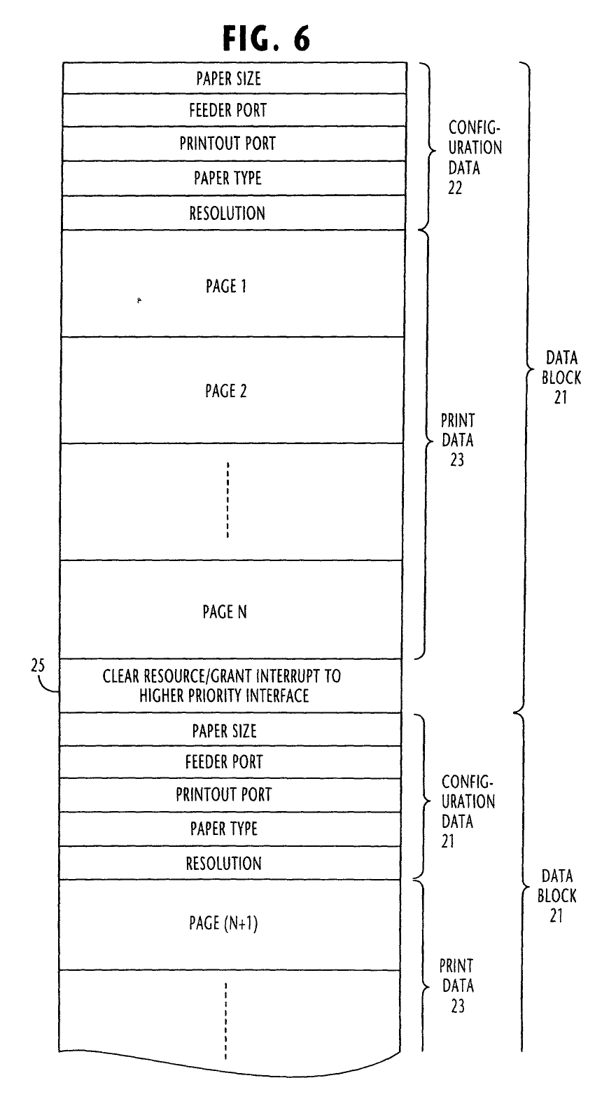

If an additional interface 6a is provided as indicated by dotted line, different priority levels can be advantageously assigned to the interfaces 6 and 6a. In FIG. 6, the command signal 25 identifies higher and lower priority interfaces. For example, interface 6 and 6a are assigned higher and lower levels of priority.

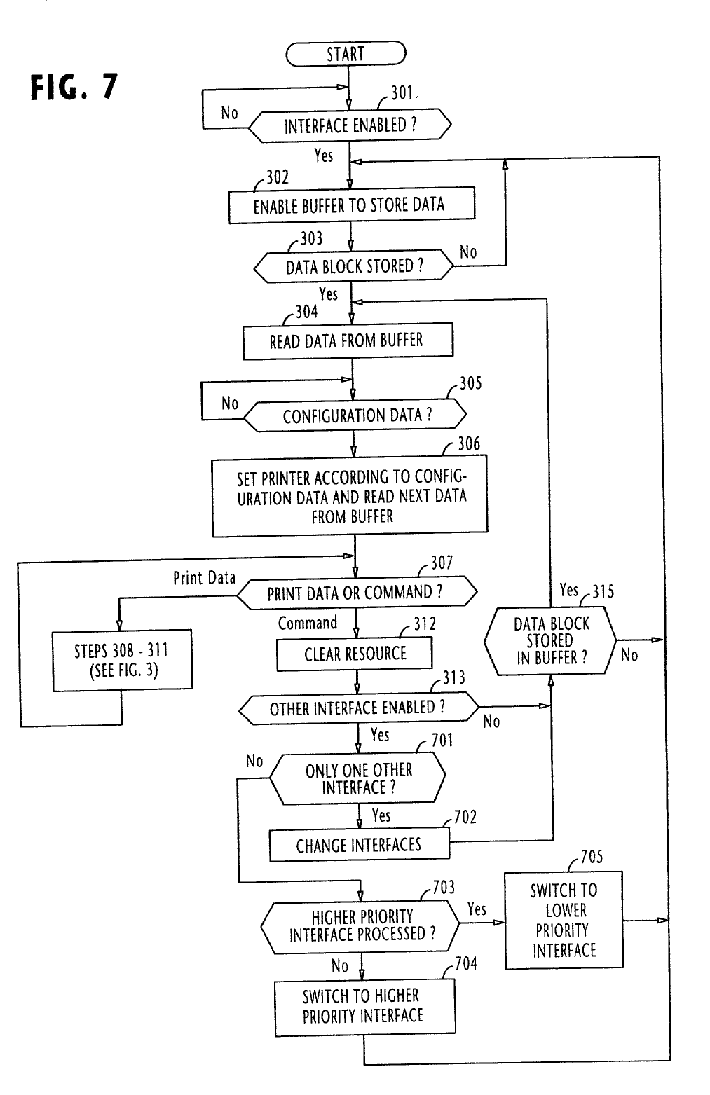

Control module 12 operates according to different priority as shown in FIG. 7, which differs from FIG. 3 in that steps 701 to 705 are additionally provided.

When the control module 12 has determined that there is an interface requesting a print interrupt from the interface 6 and/or 6a (step 313), it proceeds to step 701 to determine if there is only one interrupt request. If so, the control module 12 proceeds to step 702 to change interfaces and goes to decision step 315. If two interrupt requests are received from interfaces 6 and 6a at the same time, the control module proceeds to step 703 to determine whether the higher priority interface has been processed already. If not, the control module interrupts the current print process and switches to the higher priority interface at step 704 and returns to step 302. If data from the higher priority interface has been processed previously, the control module proceeds from step 703 to step 705 to switch to the lower priority interface before returning to step 302.

What is claimed is:

1. A printing method comprising the steps of:
dividing print data of a first print data source into a plurality of data blocks each containing a plurality of pages;
generating resource data from each data block and converting the page print data of each data block to display data by using the resource data;
printing the display data; and
clearing the resource data and granting permission to a print request from a second print data source when the display data of the first print data source has been printed.

2. A printing method for first and second print data sources, said first and second print data sources respectively producing first and second print data, each of the print data being divided into a plurality of data blocks each containing multiple pages, comprising the steps of:
a) printing a data block of said first print data when said first print data source is requesting a print of said first print data;
b) repeating step (a) if said second print data source is not producing said second print data; and
c) printing a data block of said second print data if said second print data source is requesting a print of said second print data.

3. The printing method of claim 2, wherein a number of said multiple pages contained in each of said data blocks of said first and second print data are variable.

4. The printing method of claim 2, further comprising the step of repeating step (a) or (c) depending on whether said first print data source is requesting a print of said first print data or said second print data source is requesting a print of said second print data.

5. The printing method of claim 2, wherein each of said first and second print data contains a command signal, and wherein step (b) further comprises the step of detecting the command signal in said first print data and repeating step (a) if the command signal is detected, and wherein step (c) further comprises the step of detecting the command signal in said second print data and repeating step (c) if the command signal is detected.

6. The printing method of claim 2, wherein step (a) comprises the steps of:
a₁) generating resource data from a data block of said first print data;
a₂) storing the resource data in memory;
a₃) converting each page data to display data using the resource data stored in said memory; and
a₄) clearing the resource data when the display data of said data block is printed.

7. The printing method of claim 2, wherein each of said first and second print data contains configuration data for determining a plurality of print conditions, further comprising the steps of:
storing the configuration data in a buffer; and
repeatedly using the stored configuration data when the display data of said data block is printed by either step (a) or step (c).

8. A printing method for first, second and third print data sources which produce first, second and third print data respectively, each of the first, second and third print data containing a plurality of data blocks each containing a plurality of pages, comprising the steps of:
a) assigning higher priority to said second interface and lower priority to said third interface;
b) printing a data block of said first print data when said first print data source is requesting a print of said first print data;
c) repeating step (b) if said second and third print data sources are not producing said second and third print data;
d) printing a data block of said second print data if said second print data source is requesting a print of said second print data, regardless of whether said third print data source is requesting a print of said third print data; and
e) printing a data block of said third print data if said third print data source is requesting a print of said third print data.

9. A printer controller comprising:
first and second interfaces respectively connected to first and second print data sources, said first and second print data sources respectively producing first and second print data, each of the first and second print data comprising a plurality of data blocks each containing a plurality of pages; and
a control module for receiving the first print data from said first interface if said first print data source is requesting a print of said first print data for printing on a printer, and receiving the second print data from said second interface for printing on said printer if said second print data source is requesting a print of said second print data.

10. The printer controller of claim 9, further comprising a converter for converting print data to display data, wherein said control module directs said converter to convert a data block of the first print data to display data and supplies the display data to the printer.

11. The printer controller of claim 9, further comprising at least one buffer for storing a data block of one of said first and second print data.

12. The printer controller of claim 9, further comprising first and second buffers connected to the first and second interfaces, respectively, said first buffer storing a plurality of data blocks of said first print data, and said second buffer storing a plurality of data blocks of said second print data.

13. The printer controller of claim 9, further comprising a memory, and wherein the control module has the functions of:
generating resource data from a data block of said first print data;
storing the resource data in said memory;
converting each print data to display data using the resource data stored in said memory; and
clearing said resource data when the display data of said data block has been printed.

14. The printer controller of claim 9, further comprising a buffer, and wherein each of said first and second print data contains configuration data for determining a plurality of print conditions, and said control module stores the configuration data in said buffer, and repeatedly uses the stored configuration data for setting said printer before multiple page data of next group are printed.

15. A printer controller comprising:
first, second and third interfaces respectively connected to first, second and third print data sources, said first, second and third print data sources respectively producing first, second and third print data, each of the print data comprising a plurality of data blocks each containing a plurality of pages, said second interface being assigned higher priority and said third interface being assigned lower priority; and
a control module for receiving a data block of said first print data from the first interface for printing on a printer, receiving a data block of said second print data from the second interface if a print request is received therefrom after printing has been performed on the data block of the first print data for processing on said printer, regardless of whether said third print data source is requesting a print of said third print data, and receiving a data block of the third print data from the third interface if a print request is received therefrom after printing has been performed on the data block of the second print data.

16. The printer controller of claim 15, further comprising a converter for converting print data to display data, wherein said control module directs said converter to convert a data block of the first print data to display data and supplies the display data to the printer.

17. The printer controller of claim 15, further comprising at least one buffer for storing a data block of one of said first and second print data.

18. The printer controller of claim 9, further comprising first, second and third buffers connected to the first, second and third interfaces, respectively, said first buffer storing a plurality of data blocks of said first print data, said second buffer storing a plurality of data blocks of said second print data, and said third buffer storing a plurality of data blocks of said third print data.

19. The printer controller of claim 15, further comprising a memory, and wherein the control module has the functions of:
generating resource data from a data block of said first print data;
storing the resource data in said memory;
converting the first print data to display data using the resource data stored in said memory; and
clearing said resource data when the display data of said data block has been printed.
